(19) United States
(12) Patent Application Publication
(10) Pub. No.: US 2025/0145508 A1
(43) Pub. Date: May 8, 2025

(54) METHOD AND SYSTEM FOR TREATING MATURE LANDFILL LEACHATE

(71) Applicant: Suzhou University of Science and Technology, Suzhou, Jiangsu (CN)

(72) Inventors: Xiang LI, Suzhou, Jiangsu (CN); Yong HUANG, Suzhou, Jiangsu (CN)

(21) Appl. No.: 18/681,274

(22) PCT Filed: Jul. 19, 2023
(86) PCT No.: PCT/CN2023/108136

§ 371 Date: Feb. 5, 2024

(30) Foreign Application Priority Data
Jul. 26, 2022 (CN) 202210881625.8

(51) Int. Cl. C02F 3/30; C02F 101/10; C02F 101/16; C02F 103/06

(52) U.S. Cl. CPC C02F 3/30; C02F 2101/105; C02F 2101/16; C02F 2103/06

(57) ABSTRACT

Provided are a method and a system for treating a mature landfill leachate. The mature landfill leachate is subjected to autotrophic biological nitrogen removal; an obtained nitrogen removal solution is mixed with a coagulation adsorbent, and subjected to coagulation precipitation; an obtained coagulation precipitation solid is subjected to humus extraction; an obtained crude humus product is subjected to hydrothermal reaction, and a liquid phase product obtained by the hydrothermal reaction is subjected to polymerization to obtain an aggregation medium; where the coagulation adsorbent comprises an adsorption reagent and the aggregation medium; an obtained coagulation precipitation solution is subjected to electrochemical oxidation; an obtained effluent from the electrochemical oxidation is subjected to deep nitrogen and phosphorus removal; and a humus extraction residue, an electrochemical oxidation residue, and a deep nitrogen and phosphorus removal residue are subjected to phosphorus recovery to obtain a supernatant and a crude vivianite product.

### CROSS REFERENCE TO RELATED APPLICATION

This application is a national stage application of International Patent Application No. PCT/CN2023/108136, filed on Jul. 19, 2023, which claims priority to the Chinese Patent Application No. 202210881625.8, filed with the China National Intellectual Property Administration (CNIPA) on Jul. 26, 2022, and entitled “METHOD AND SYSTEM FOR TREATING MATURE LANDFILL LEACHATE”. The disclosure of the two patent applications is incorporated by references in their entireties.

### TECHNICAL FIELD

The present disclosure belongs to the technical field of mature landfill leachate treatment, and specifically relates to a method and a system for treating a mature landfill leachate.

### BACKGROUND

In recent decades, sanitary landfill has been the main approach of waste disposal in China. The landfill leachate produced during landfill is one of the high-concentration wastewater types that is difficult to treat in the current water environment and is extremely harmful to the human body and environment. The leachate that has been landfilled for not less than 8 years is called a mature landfill leachate, which is difficult to treat due to a low biochemical oxygen demand (BOD)/chemical oxygen demand (COD) ratio (also called a B/C ratio) of 0.1 to 0.2, a high concentration, and a complex composition.

Currently, the mature landfill leachate is treated through a deep treatment process of nitrification, denitrification, and nitrogen and carbon removal coupled with ultrafiltration membranes, nanofiltration membranes, and reverse osmosis membranes. However, the deep treatment process requires a large amount of additional organic matters and a high energy consumption. Moreover, a membrane concentrated phase (reverse osmosis concentrate) produced during the treatment of the nanofiltration membranes and the reverse osmosis membranes is re-injected into the landfill, which aggravates environmental pollution to a certain extent.

### SUMMARY

In view of this, an object of the present disclosure is to provide a method for treating a mature landfill leachate. The treatment method does not require a large amount of additional organic matters, and residues after the treatment of the mature landfill leachate can be completely recovered to achieve resource utilization.

In order to achieve the above object, the present disclosure provides a method for treating a mature landfill leachate, including the following steps:
subjecting the mature landfill leachate to autotrophic biological nitrogen removal to obtain a nitrogen removal solution;
mixing the nitrogen removal solution with a coagulation adsorbent, and conducting coagulation precipitation to obtain a coagulation precipitation solid and a coagulation precipitation solution; subjecting the coagulation precipitation solid to humus extraction to obtain a crude humus product and a humus extraction residue; subjecting the crude humus product to hydrothermal reaction, and subjecting a liquid phase product obtained by the hydrothermal reaction to polymerization to obtain an aggregation medium; where the coagulation adsorbent includes an adsorption reagent and the aggregation medium;
subjecting the coagulation precipitation solution to electrochemical oxidation to obtain an electrochemical oxidation solution and an electrochemical oxidation residue;
mixing the electrochemical oxidation solution with a nitrogen and phosphorus removal agent, and conducting deep nitrogen and phosphorus removal to obtain a deep nitrogen and phosphorus removal solution and a deep nitrogen and phosphorus removal residue, where the nitrogen and phosphorus removal agent includes a pyrite particle and/or a ferrihydrite particle; and the deep nitrogen and phosphorus removal is sulfur autotrophic denitrification (SAD)-anaerobic ammonium oxidation (anammox) and chemical phosphorus removal; and
subjecting the humus extraction residue, the electrochemical oxidation residue, and the deep nitrogen and phosphorus removal residue to phosphorus recovery to obtain a supernatant and a crude vivianite product.

In some embodiments, the autotrophic biological nitrogen removal is conducted at a temperature of 15° C. to 35° C. with a pH value of 7.5 to 8.5.

In some embodiments, the autotrophic biological nitrogen removal is selected from the group consisting of an aerobic-anaerobic biological treatment and a hypoxic treatment.

In some embodiments, the aerobic-anaerobic biological treatment includes an aerobic biological treatment and an anaerobic biological treatment in sequence, the aerobic biological treatment is conducted at a dissolved oxygen (DO) concentration of 1 mg/L to 3 mg/L with a retention time of 1 h to 24 h; and the anaerobic biological treatment is conducted with a retention time of 1 h to 12 h.

In some embodiments, the hypoxic treatment is conducted at a DO concentration of 0.1 mg/L to 1 mg/L with a retention time of 1 h to 24 h.

In some embodiments, the adsorption reagent includes one or more selected from the group consisting of ferric chloride, ferrous sulfate, or polyferric chloride.

In some embodiments, the electrochemical oxidation is conducted at a current of 340 mA/cm² to 360 mA/cm², with a hydraulic retention time of 0.5 h to 2 h and a distance between a cathode plate and an anode plate of 10 cm to 30 cm.

In some embodiments, the nitrogen and phosphorus removal agent has a particle size of 0.8 mm to 1.2 mm, a pH value of 7 to 8, and a temperature of 20° C. to 35° C.

In some embodiments, the phosphorus recovery is conducted in an anaerobic environment with a redox potential of not greater than-100 mV and a pH value of 5 to 8.

The present disclosure further provides a system for treating a mature landfill leachate, including:
an autotrophic biological nitrogen removal tank 1;
a coagulation precipitation tank 2 connected to a nitrogen removal solution outlet of the autotrophic biological nitrogen removal tank 1;
an electrochemical oxidation tank 3 connected to a coagulation precipitation solution outlet of the coagulation precipitation tank 2, where the electrochemical oxidation tank 3 is provided with an electrochemical oxidation residue outlet;
a deep nitrogen and phosphorus removal tank 4 connected to an electrochemical oxidation solution outlet of the electrochemical oxidation tank 3, where the deep nitrogen and phosphorus removal tank 4 is provided with a deep nitrogen and phosphorus removal residue outlet;
a phosphorus recovery tank 5 connected to the deep nitrogen and phosphorus removal residue outlet of the deep nitrogen and phosphorus removal tank 4, where the phosphorus recovery device 5 is provided with a residue inlet; and
a humus extraction tank 6 connected to a coagulation precipitation solid outlet of the coagulation precipitation tank 2, where the humus extraction tank 6 is provided with a humus extraction residue outlet; and the residue inlet of the phosphorus recovery device 5 is connected to the electrochemical oxidation residue outlet, the deep nitrogen and phosphorus removal residue outlet, and the humus extraction residue outlet;
the system further including a hydrothermal reaction device 7 and a polymerization device 8.

The present disclosure provides a method for treating a mature landfill leachate, including the following steps: subjecting the mature landfill leachate to autotrophic biological nitrogen removal to obtain a nitrogen removal solution; mixing the nitrogen removal solution with a coagulation adsorbent, and conducting coagulation precipitation to obtain a coagulation precipitation solid and a coagulation precipitation solution; subjecting the coagulation precipitation solid to humus extraction to obtain a crude humus product and a humus extraction residue; subjecting the crude humus product to hydrothermal reaction, and subjecting a liquid phase product obtained by the hydrothermal reaction to polymerization to obtain an aggregation medium; where the coagulation adsorbent includes an adsorbent and the aggregation medium; subjecting the coagulation precipitation solution to electrochemical oxidation to obtain an electrochemical oxidation solution and an electrochemical oxidation residue; mixing the electrochemical oxidation solution with a nitrogen and phosphorus removal agent, and conducting deep nitrogen and phosphorus removal to obtain a deep nitrogen and phosphorus removal solution and a deep nitrogen and phosphorus removal residue, where the nitrogen and phosphorus removal agent includes a pyrite particle and/or a ferrihydrite particle; and the deep nitrogen and phosphorus removal is SAD-anammox and chemical phosphorus removal; and subjecting the humus extraction residue, the electrochemical oxidation residue, and the deep nitrogen and phosphorus removal residue to phosphorus recovery to obtain a supernatant and a crude vivianite product. In the present disclosure, the autotrophic biological nitrogen removal degrades ammonia-nitrogen and degradable organic matters in the mature landfill leachate. The coagulation precipitation causes macromolecular refractory organic matters and a part of phosphate in the autotrophic biological nitrogen removal solution to coagulate and precipitate. In this way, organic and phosphorus loads of subsequent electrochemical oxidation are reduced, thereby reducing an electrochemical energy consumption. The electrochemical oxidation can result in oxidative degradation of refractory organic matters with a relatively small molecular weight. The electrochemical oxidation solution obtained after the oxidative degradation is subjected to deep nitrogen and phosphorus removal (SAD-anammox and chemical phosphorus removal) using pyrite particles or ferrihydrite particles as carriers. The SAD can reduce nitrate in the electrochemical oxidation solution into nitrite; the nitrite and ammonia-nitrogen generate nitrogen through the anammox to achieve nitrogen removal. Meanwhile, SAD bacteria can oxidize the pyrite or ferrihydrite using nitrate in the electrochemical oxidation solution as an oxidant to obtain Fe³⁺; the Fe³⁺ complexes with the phosphate radical in the electrochemical oxidation solution to form a Fe-phosphate radical complex, which is retained in the deep nitrogen and phosphorus removal residue. In addition, the coagulation precipitation solid is further subjected to the humus extraction to obtain the crude humus product; the crude humus product is subjected to the hydrothermal reaction and polymerization to form the coagulation adsorbent, which is continuously used for coagulation precipitation. Moreover, the extraction residue, electrochemical oxidation residue, and deep nitrogen and phosphorus removal residue are subjected to phosphorus recovery. During the phosphorus recovery, a small amount of organic matters present in the residue can reduce Fe³⁺ in the residue into Fe²⁺ in an anaerobic environment. The Fe²⁺ reacts with phosphate radical to generate the crude vivianite product, thereby realizing recovery of phosphate radical in the form of vivianite.

The present disclosure further provides a system for treating a mature landfill leachate, including: an autotrophic biological nitrogen removal tank 1; a coagulation precipitation tank 2 connected to a nitrogen removal solution outlet of the autotrophic biological nitrogen removal tank 1; an electrochemical oxidation tank 3 connected to a coagulation precipitation solution outlet of the coagulation precipitation tank 2, where the electrochemical oxidation tank 3 is provided with an electrochemical oxidation residue outlet; a deep nitrogen and phosphorus removal tank 4 connected to an electrochemical oxidation solution outlet of the electrochemical oxidation tank 3, where the deep nitrogen and phosphorus removal tank 4 is provided with a deep nitrogen and phosphorus removal residue outlet; a phosphorus recovery tank 5 connected to the deep nitrogen and phosphorus removal residue outlet of the deep nitrogen and phosphorus removal tank 4, where the phosphorus recovery device 5 is provided with a residue inlet; a humus extraction tank 6 connected to a coagulation precipitation solid outlet of the coagulation precipitation tank 2, where the humus extraction tank 6 is provided with a humus extraction residue outlet; and the residue inlet is connected to the electrochemical oxidation residue outlet, the deep nitrogen and phosphorus removal residue outlet, and the humus extraction residue outlet; and further including a hydrothermal reaction device 7 and a polymerization device 8. In the present disclosure, the system shows low energy consumption and operating costs when treating the mature landfill leachate, and can realize the recovery and resource utilization of some substances in the mature landfill leachate.

### BRIEF DESCRIPTION OF THE DRAWINGS

FIG. 1 shows a process flow diagram of the method for treating a mature landf illleachate.

### DETAILED DESCRIPTION OF THE EMBODIMENTS

The present disclosure provides a method for treating a mature landfill leachate, including the following steps:
subjecting the mature landfill leachate to autotrophic biological nitrogen removal to obtain a nitrogen removal solution;
mixing the nitrogen removal solution with a coagulation adsorbent, and conducting coagulation precipitation to obtain a coagulation precipitation solid and a coagulation precipitation solution; subjecting the coagulation precipitation solid to humus extraction to obtain a crude humus product and a humus extraction residue; subjecting the crude humus product to hydrothermal reaction, and subjecting a liquid phase product obtained by the hydrothermal reaction to polymerization to obtain an aggregation medium; where the coagulation adsorbent includes an adsorption reagent and the aggregation medium;
subjecting the coagulation precipitation solution to electrochemical oxidation to obtain an electrochemical oxidation solution and an electrochemical oxidation residue;
mixing the electrochemical oxidation solution with a nitrogen and phosphorus removal agent, and conducting deep nitrogen and phosphorus removal to obtain a deep nitrogen and phosphorus removal solution and a deep nitrogen and phosphorus removal residue, where the nitrogen and phosphorus removal agent includes a pyrite particle and/or a ferrihydrite particle; and the deep nitrogen and phosphorus removal is sulfur autotrophic denitrification (SAD)-anaerobic ammonium oxidation (anammox) and chemical phosphorus removal; and
subjecting the humus extraction residue, the electrochemical oxidation residue, and the deep nitrogen and phosphorus removal residue to phosphorus recovery to obtain a supernatant and a crude vivianite product.

In some embodiments of the present disclosure, raw materials provided herein are all commercially-available products unless otherwise specified.

In the present disclosure, the mature landfill leachate is subjected to autotrophic biological nitrogen removal to obtain a nitrogen removal solution.

In the present disclosure, there is no specific limitation on the source of the mature landfill leachate, as long as it is a mature landfill leachate that can be obtained by those skilled in the art. In some embodiments, the specific components of the mature landfill leachate include refractory organic matters, ammonia-nitrogen, organic nitrogen, and phosphate.

In some embodiments of the present disclosure, the autotrophic denitrification is conducted at a temperature of 15° C. to 35° C., preferably 20° C. to 30° C. with a pH value of 7.5 to 8.5, preferably 7.8 to 8.2.

In some embodiments of the present disclosure, the autotrophic biological nitrogen removal is selected from the group consisting of an aerobic-anaerobic biological treatment and a hypoxic treatment. In some embodiments, under the condition that the autotrophic biological nitrogen removal is the aerobic-anaerobic biological treatment, the aerobic-anaerobic biological treatment is conducted by an acrobic biological treatment and an anaerobic biological treatment in sequence; in some embodiments, the aerobic biological treatment is conducted at a dissolved oxygen (DO) concentration of 1 mg/L to 3 mg/L, preferably 1.5 mg/L to 2.5 mg/L with a retention time of 1 h to 24 h, preferably 15 h. In some embodiments, the anaerobic biological treatment is conducted with a retention time of 1 h to 12 h, preferably 8 h. In some embodiments, under the condition that the autotrophic biological nitrogen removal is the hypoxic treatment, the hypoxic treatment is conducted at a DO concentration of 0.1 mg/L to 1 mg/L, preferably 0.2 mg/L to 0.5 mg/L with a retention time of 1 h to 24 h, preferably 15 h.

In the present disclosure, after obtaining the nitrogen removal solution, the nitrogen removal solution is mixed with a coagulation adsorbent, and subjected to coagulation precipitation to obtain a coagulation precipitation solid and a coagulation precipitation solution.

In the present disclosure, the coagulation adsorbent includes an adsorption reagent and an aggregation medium;

The treatment of the mature landfill leachate is a cyclic process. During first coagulation precipitation, the adsorption agent is required to be added for coagulation precipitation. In some embodiments, the adsorbent includes one or more selected from the group consisting of ferric chloride, ferrous sulfate, and polyferric chloride, preferably being the ferric chloride. In some embodiments, in the subsequent circulation, the coagulation adsorbent is the aggregation medium.

In some emdobidments of the present disclosure, the coagulation precipitation is conducted under stirring; in some embodiments, the stirring is conducted at a rotational speed of 50 rpm to 100 rpm, preferably 50 rpm for 1 h to 3 h, and preferably 3 h.

In the present disclosure, the coagulation precipitation can precipitate macromolecular organic matters, such as humic acid and fulvic acid, while the coagulation adsorbent can complex with phosphate radical to remove part of the phosphate radical.

In the present disclosure, after obtaining the coagulation precipitation solid, the coagulation precipitation solid is subjected to humus extraction to obtain a crude humus product and a humus extraction residue.

In some embodiments of the present disclosure, the humus extraction is conducted at a temeprature of 0° C. to 100° C., preferably 80° C. In some embodiments, the humus extraction is conducted under stirring; in some embodiments, the stirring is conducted at a rotational speed of 10 rpm to 100 rpm, preferably 50 rpm for 0.5 h to 2 h, preferably 1 h. In some embodiments, the humus extraction is run in a sequential batch mode.

In some embodiments of the present disclosure, after the humus extraction is completed, a resulting crude humus product is subjected to hydrothermal reaction, a system obtained by the hydrothermal reaction is subjected to solid-liquid separation, and a liquid phase product obtained by the solid-liquid separation is subjected to polymerization.

In some embodiments of the present disclosure, the hydrothermal reaction is conducted by heating in a closed environment for 2 h to 4 h. A final temperature of the heating is in a range of 160° C. to 220° C. In some embodiments, the solid-liquid separation results in a hydrothermal carbon and the liquid phase product; and in some embodiments, the hydrothermal carbon is recycled.

In some embodiments of the present disclosure, the polymerization is performed by adding a monomer, and an initiator modifier into the liquid phase product obtained by the hydrothermal reaction, and conducting reaction to obtain an aggregation medium with adsorption aggregation and separation characteristics.

In some embodiments of the present disclosure, the monomer is a quaternary ammonium salt or acrylamide; in some embodiments, the quaternary ammonium salt is dimethylaminocthyl methacrylate quaternary ammonium salt; in some embodiments, the initiator is persulfate; and in some embodiments, the persulfate is potassium persulfate. In some embodiments, the polymerization is conducted at a temperature of 40° C. to 70° C. for 2 h to 4 h.

In the present disclosure, the aggregation medium is used for coagulation precipitation.

In the present disclosure, after obtaining the coagulation precipitation solution, the coagulation precipitation solution is subjected to electrochemical oxidation to obtain an electrochemical oxidation solution and an electrochemical oxidation residue.

In some embodiments of the present disclosure, the electrochemical oxidation is conducted at a current of 340-360 mA/cm², preferably 350 mA/cm², with a hydraulic retention time of 0.5 h to 2 h, preferably 1 h to 1.5 h. In some embodiments, the electrochemical oxidation uses pulse current as a power source; and in some embodiments, cathode and anode plates for the electrochemical oxidation are a ruthenium-iridium plate and an iron plate, respectively. In some embodiments, in the the electrochemical oxidation, a distance between the cathode plate and the anode plate is in a range of 10 cm to 30 cm, preferably 15 cm to 25 cm. A number of the cathode and anode plates depends on a size of the reactor and a concentration of the organic matters in an effluent obtained after the coagulation precipitation.

In the present disclosure, the electrochemical oxidation can degrade small-molecule refractory organic matters in the coagulation precipitation solution, and has a low pollution load, and reduced energy and material consumptions of the electrochemical oxidation.

In the present disclosure, after obtaining the electrochemical oxidation solution, the electrochemical oxidation solution is mixed with a nitrogen and phosphorus removal agent, and subjected to deep nitrogen and phosphorus removal to obtain a deep nitrogen and phosphorus removal solution and a deep nitrogen and phosphorus removal residue, where the nitrogen and phosphorus removal agent includes a pyrite particle and/or a ferrihydrite particle; and the deep nitrogen and phosphorus removal is SAD-anammox and chemical phosphorus removal.

In the present disclosure, the deep nitrogen and phosphorus removal agent includes the pyrite particle and/or ferrihydrite particle, preferably being the pyrite particle; and in some embodiments, the deep nitrogen and phosphorus removal agent has a particle size of 0.8 mm to 1.2 mm, preferably 1 mm. In some embodiments, the deep nitrogen and phosphorus removal is conducted at a pH value of 7 to 8, preferably 7.2 to 7.5; and in some embodiments, the deep nitrogen and phosphorus removal is conducted at a temperature of 20° C. to 35° C., preferably 25° C. to 30° C.

In some embodiments of the present disclosure, the deep nitrogen and phosphorus removal is the SAD-anammox and chemical phosphorus removal.

In some embodiments of the present disclosure, the SAD-anammox is conducted by: reducing a nitrate in the electrochemical oxidation solution into a nitrite with Thiobacillus denitrificans in an anaerobic environment; and converting ammonia-nitrogen and the nitrite in the electrochemical oxidation solution into nitrogen under the action of anammox bacteria, thereby achieving the removal of the nitrate and ammonia-nitrogen in the water. In the SAD, in an anaerobic environment, the Thiobacillus denitrificans oxidize pyrite to obtain Fe³⁺ with the nitrate in the water as an oxidant.

In some embodiments of the present disclosure, the chemical phosphorus removal is conducted by complexing Fe³⁺ obtained during the denitrification with phosphate radical in the electrochemical oxidation solution to remove phosphate radical.

In some embodiments of the present disclosure, the deep nitrogen and phosphorus removal preferably further includes gas backwashing; and backwashing water obtained from the gas backwashing is mixed with the nitrogen removal solution, and subjected to coagulation precipitation. In some embodiments, the gas backwashing and the coagulation precipitation are at a time ratio of 1:23.

In the present disclosure, the nitrogen removal and the phosphorus removal can be completed simultaneously.

In some embodiments of the present disclosure, the deep nitrogen and phosphorus removal solution has a chemical oxygen demand (COD) concentration of less than 100 mg/L, a biochemical oxygen demand (BOD) concentration of less then 30 mg/L, a total nitrogen concentration of less than 40 mg/L, an ammonia-nitrogen concentration of less than 25 mg/L, and a total phosphorus concentration of less than 3 mg/L.

In the present disclosure, after obtaining the deep nitrogen and phosphorus removal residue, the humus extraction residue, the electrochemical oxidation residue, and the deep nitrogen and phosphorus removal residue are subjected to phosphorus recovery to obtain a supernatant and a crude vivianite product.

In some embodiments of the present disclosure, the phosphorus recovery is conducted in an anaerobic environment; in some embodiments, the phosphorus recovery is conducted at a redox potential of not greater than −100 mV, preferably −100 mV to −500 mV; in some embodiments, the phosphorus recovery is conducted at a pH value of 5 to 8, preferably 6 to 7; in some embodiments, the phosphorus recovery is conducted under stirring; and in some embodiments, the stirring is conducted at a rotational of 50 rpm to 100 rpm, preferably 60 rpm to 80 rpm for 1 h to 50 h, preferably 1 h.

In the present disclosure, the phosphorus recovery can result in a crude vivianite product, thereby realizing resource recovery of phosphate in the form of vivianite. At the same time, the formation of vivianite and the increase in particle size thereof are achieved by strictly limiting the conditions for phosphorus recovery.

In the present disclosure, during the phosphorus recovery, in an anaerobic environment, a small amount of organic maters present in the deep nitrogen and phosphorus removal residue, the extraction residue, and the electrochemical oxidation residue can reduce Fe³⁺ in the residue into Fe²⁺, and the Fe²⁺ reacts with phosphate radical to generate the crude vivianite product.

In some embodiments of the present disclosure, the supernatant is mixed with the nitrogen removal solution and then subjected to coagulation precipitation. In the present disclosure, the supernatant includes the adsorbent that is not bound with phosphorus element, and is mixed with the nitrogen removal solution, and then subjected to coagulation precipitation.

The present disclosure further provides a system for treating a mature landfill leachate, including: an autotrophic biological nitrogen removal tank 1; where the autotrophic nitrogen removal tank 1 is provided with a liquid inlet and a nitrogen removal solution outlet.

In the present disclosure, the system includes a coagulation precipitation tank 2 connected to the nitrogen removal solution outlet of the autotrophic biological nitrogen removal tank 1; the coagulation precipitation tank 2 is provided with a liquid inlet, a coagulation precipitation solid outlet, and a coagulation precipitation solution outlet; the liquid inlet of the coagulation precipitation tank 2 is connected with the nitrogen removal solution outlet; the coagulation precipitation tank is provided with a high-speed stirring zone, a low-speed stirring zone, and a precipitation zone; the high-speed stirring zone and the low-speed stirring zone each are equipped with a stirrer; the coagulation precipitation solid outlet and the coagulation precipitation solution outlet are arranged in the precipitation zone.

In the present disclosure, the system includes an electrochemical oxidation tank 3 connected to the coagulation precipitation solution outlet of the coagulation precipitation tank 2; the electrochemical oxidation tank 3 is provided with a liquid inlet, an electrochemical oxidation solution outlet, and an electrochemical oxidation residue outlet; and the liquid inlet of the electrochemical oxidation tank 3 is connected with the coagulation precipitation solution outlet.

In the present disclosure, the system includes a deep nitrogen and phosphorus removal tank 4 connected to the electrochemical oxidation solution outlet; the deep nitrogen and phosphorus removal tank 4 is provided with a liquid inlet, a deep nitrogen and phosphorus removal solution outlet, and a deep nitrogen and phosphorus removal residue outlet; the liquid inlet of the deep nitrogen and phosphorus removal tank 4 is connected with the electrochemical oxidation solution outlet; and the deep nitrogen and phosphorus removal tank 4 is further provided with a gas flushing device.

In the present disclosure, the system includes a humus extraction tank 6 connected with the coagulation precipitation solid outlet of the coagulation precipitation tank 2; the humus extraction tank 6 is provided with a coagulation precipitation solid inlet, a humus extraction residue outlet, and a crude humus product outlet; the coagulation precipitation solid inlet of the humus extraction tank 6 is connected with the coagulation precipitation solid outlet of the coagulation precipitation tank 2; and the humus extraction tank 6 is further provided with a stirrer.

In the present disclosure, the system includes a phosphorus recovery tank 5 connected to the deep nitrogen and phosphorus removal residue outlet of the deep nitrogen and phosphorus removal tank 4; the phosphorus recovery device 5 is provided with a residue inlet and a vivianite outlet; and the residue inlet is connected with the electrochemical oxidation residue outlet, the deep nitrogen and phosphorus removal residue outlet, and the extraction residue outlet. In the present disclosure, the phosphorus recovery tank 5 is provided with a main reaction zone and a precipitation zone, and the main reaction zone is provided with a stirrer.

In the present disclosure, the system further includes a hydrothermal reaction device 7 and a polymerization device 8.

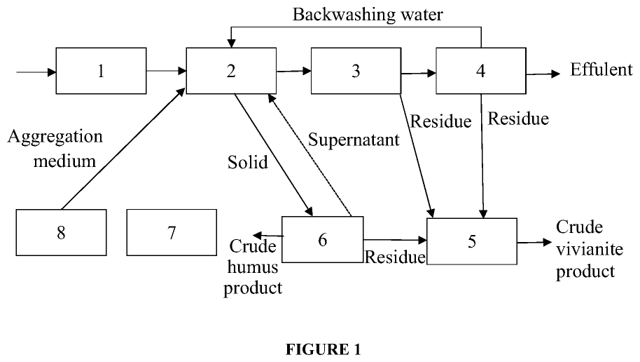

FIG. 1 shows a process flow chart of the method for treating a mature landfill leachate according to the present disclosure. The above method is described with reference to FIG. 1 and the system for treating a mature landfill leachate provided by the present disclosure:
the mature landfill leachate is introduced into a autotrophic biological nitrogen removal tank 1, and subjected to autotrophic biological nitrogen removal to obtain a nitrogen removal solution;
the nitrogen removal solution is introduced into a coagulation precipitation tank 2, and a coagulation adsorbent is added into the coagulation precipitation tank 2, and subjected to coagulation precipitation to obtain a coagulation precipitation solid and a coagulation precipitation solution;
the coagulation precipitation solid is introduced into a humus extraction tank 6, and subjected to humus extraction to obtain a crude humus product and a humus extraction residue;
the crude humus product is introduced into a hydrothermal reaction device 7, and subjected to hydrothermal reaction, a liquid phase product obtained by the hydrothermal reaction is introduced into a polymerization device 8, and subjected to polymerization to obtain an aggregation medium; and the aggregation medium is added into the coagulation precipitation tank 2 for coagulation precipitation;
the coagulation precipitation solution is introduced into an electrochemical oxidation tank 3, and subjected to electrochemical oxidation to obtain an electrochemical oxidation solution and an electrochemical oxidation residue;
the electrochemical oxidation solution is introduced into a deep nitrogen and phosphorus removal tank 4, and subjected to deep nitrogen and phosphorus removal to obtain a deep nitrogen and phosphorus removal solution and a deep nitrogen and phosphorus removal residue; and
the humus extraction residue, the electrochemical oxidation residue, and the deep nitrogen and phosphorus removal residue are introduced into a phosphorus recovery tank 5, and subjected to phosphorus recovery, to obtain a supernatant and a crude vivianite product.

In order to further illustrate the present disclosure, the method and the system provided by the present disclosure are described in detail below in conjunction with examples, but these examples should not be understood as limiting the scope of the present disclosure.

### Example 1

a mature landfill leachate was collected from the Qizishan landfill in Suzhou, China and had been landfilled for nearly 20 years. The mature landfill leachate had a COD concentration of 2,500 mg/L, a BOD concentration of 1,200 mg/L, an ammonia-nitrogen concentration of 2,500 mg/L, a total nitrogen concentration of 3,000 mg/L, a total phosphorus concentration of 20 mg/L, and a pH value of 8.

(1) The mature landfill leachate was added into an autotrophic biological nitrogen removal tank 1, and subjected to autotrophic biological nitrogen removal to obtain a nitrogen removal solution, where the autotrophic biological nitrogen removal was conducted by an aerobic biological treatment and an anaerobic biological treatment in sequence. The aerobic biological treatment was conducted with a DO concentration of 1.5 mg/L and a retention time of 20 h at a pH value of 8 and a temperature of 35° C.; and the anaerobic biological treatment was conducted at a pH value of 8 and a temperature of 35° C. with a retention time of 12 h. A resulting effluent had a COD concentration of 1,300 mg/L, a BOD concentration of 50 mg/L, an ammonia-nitrogen concentration of 50 mg/L, a total nitrogen concentration of 80 mg/L, a total phosphorus concentration of 20 mg/L, and a pH value of 8.

(2) The nitrogen removal solution was added into a coagulation precipitation tank 2, ferric chloride was added, and stirred at a rotational speed of 80 rpm for 1 h to obtain a coagulation precipitation solid and a coagulation precipitation solution. The coagulation precipitation solid was added into a humus extraction tank 6, and subjected to humus extraction at a temperature of 80° C. and a rotational speed of 50 rpm for 1 h to obtain a crude humus product and a humus extraction residue. A resulting effluent had a COD concentration of 400 mg/L, a BOD concentration of 33 mg/L, an ammonia-nitrogen concentration of 43 mg/L, a total nitrogen concentration of 52 mg/L, a total phosphorus concentration of 3 mg/L, and a pH value of 7.5.

The crude humus product was added into a hydrothermal reaction device 7 and subjected to hydrothermal reaction by heating for 3 h, with a final temperature of 200° C.; and acrylamide and potassium persulfate were added into a liquid phase product obtained by the hydrothermal reaction, and subjected to polymerization to obtain an aggregation medium.

(3) The coagulation precipitation solution was added into an electrochemical oxidation tank 3, and subjected to electrochemical oxidation to obtain an electrochemical oxidation solution and an electrochemical oxidation residue, where the electrochemical oxidation was conducted with pulse current as a power source, a ruthenium-iridium plate and an iron plate as cathode and anode plates, respectively, and a distance between the cathode and anode plates of 20 cm, and 4 in total of the cathode and anode plates, a current density of 350 mA/cm² and a hydraulic retention time of 1 h. A resulting effluent had a COD concentration of 80 mg/L, a BOD concentration of 30 mg/L, an ammonia-nitrogen concentration of 10 mg/L, a total nitrogen concentration of 45 mg/L, a total phosphorus concentration of 0.8 mg/L, and a pH value of 8.

(4) The electrochemical oxidation solution was added into a deep nitrogen and phosphorus removal tank 4, and subjected to deep nitrogen and phosphorus removal (SAD-anammox and chemical phosphorus removal) to obtain a deep nitrogen and phosphorus removal solution and a deep nitrogen and phosphorus removal residue. Pyrite with a particle size of 1 mm was added to the deep nitrogen and phosphorus removal tank, and the deep nitrogen and phosphorus removal tank had a pH value of 7 and a temperature of 25° C.; a bacterium used for the SAD was Thiobacillus denitrificans. A resulting effluent had a COD concentration of 53 mg/L, a BOD concentration of 10 mg/L, an ammonia-nitrogen concentration of 5 mg/L, a total nitrogen concentration of 11.7 mg/L, a total phosphorus concentration of 0.5 mg/L, and a pH value of 7.5.

(5) The humus extraction residue, the electrochemical oxidation residue, and the deep nitrogen and phosphorus removal residue were added into a phosphorus recovery tank and subjected to phosphorus recovery, obtaining a supernatant and a crude vivianite product. The phosphorus recovery was conducted by stirring in an anaerobic environment at a redox potential of −230 mV, a pH value of 7, and a rotational speed of 80 rpm for 1 h.

An effluent obtained after the deep nitrogen and phosphorus removal had a COD concentration of 53 mg/L, a BOD concentration of 10 mg/L, a total nitrogen concentration of 11.7 mg/L, an ammonia-nitrogen concentration of 5 mg/L, and a total phosphorus concentration of 0.5 mg/L, which met the effluent standard of GB 16889-2008 “Standard for Pollution Control on the Landfill Site of Municipal Solid Waste”.

In the present disclosure, a crude vivianite product was also obtained after treating the mature landfill leachate, and the obtained aggregation medium could be used for subsequent coagulation precipitation, thereby realizing resource utilization.

The above descriptions are merely preferred embodiments of the present disclosure. It should be noted that a person of ordinary skill in the art may further make several improvements and modifications without departing from the principle of the present disclosure, but such improvements and modifications shall be deemed as falling within the scope of the present disclosure.

What is claimed is:

1. A method for treating a mature landfill leachate, comprising the following steps:
subjecting the mature landfill leachate to autotrophic biological nitrogen removal to obtain a nitrogen removal solution;
mixing the nitrogen removal solution with a coagulation adsorbent, and conducting coagulation precipitation to obtain a coagulation precipitation solid and a coagulation precipitation solution;
subjecting the coagulation precipitation solid to humus extraction to obtain a crude humus product and a humus extraction residue; subjecting the crude humus product to hydrothermal reaction, and subjecting a liquid phase product obtained by the hydrothermal reaction to polymerization to obtain an aggregation medium; wherein the coagulation adsorbent comprises an adsorption reagent and the aggregation medium;
subjecting the coagulation precipitation solution to electrochemical oxidation to obtain an electrochemical oxidation solution and an electrochemical oxidation residue;
mixing the electrochemical oxidation solution with a nitrogen and phosphorus removal agent, and conducting deep nitrogen and phosphorus removal to obtain a deep nitrogen and phosphorus removal solution and a deep nitrogen and phosphorus removal residue, wherein the nitrogen and phosphorus removal agent comprises pyrite particles and/or ferrihydrite particles;
and the deep nitrogen and phosphorus removal is sulfur autotrophic denitrification (SAD)-anaerobic ammonium oxidation (anammox) and chemical phosphorus removal; and
subjecting the humus extraction residue, the electrochemical oxidation residue, and the deep nitrogen and phosphorus removal residue to phosphorus recovery to obtain a supernatant and a crude vivianite product.

2. The method of claim 1, wherein the autotrophic biological nitrogen removal is conducted at a temperature of 15° C. to 35° C. with a pH value of 7.5 to 8.5.

3. The method of claim 1, wherein the autotrophic biological nitrogen removal is selected from the group consisting of an aerobic-anaerobic biological treatment and a hypoxic treatment.

4. The method of claim 3, wherein the aerobic-anaerobic biological treatment comprises an aerobic biological treatment and an anaerobic biological treatment in sequence, the aerobic biological treatment is conducted at a dissolved oxygen (DO) concentration of 1 mg/L to 3 mg/L with a retention time of 1 h to 24 h; and the anaerobic biological treatment is conducted with a retention time of 1 h to 12 h.

5. The method of claim 3, wherein the hypoxic treatment is conducted at a DO concentration of 0.1 mg/L to 1 mg/L with a retention time of 1 h to 24 h.

6. The method of claim 1, wherein the adsorption reagent comprises one or more selected from the group consisting of ferric chloride, ferrous sulfate, and polyferric chloride.

7. The method of claim 1, wherein the humus extraction is conducted at a temperature of 0° C. to 100° C. for 0.5 h to 2 h.

8. The method of claim 1, wherein the hydrothermal reaction is conducted by heating in a closed environment for 2 h to 4 h with a final temperature of 160° C. to 220° C.

9. The method of claim 1, wherein the polymerization is performed by adding a monomer, and an initiator modifier to the liquid phase product obtained by the hydrothermal reaction, and conducting reaction, wherein the monomer is selected from the group consisting of a quaternary ammonium salt and acrylamide, the initiator is a persulfate, and the persulfate is potassium persulfate.

10. The method of claim 1, wherein the polymerization is conducted at a temperature of 40° C. to 70° C. for 2 h to 4 h.

11. The method of claim 1, wherein the electrochemical oxidation is conducted at a current of 340 mA/cm² to 360 mA/cm², with a hydraulic retention time of 0.5 h to 2 h and a distance between a cathode plate and an anode plate of 10 cm to 30 cm.

12. The method of claim 1, wherein the nitrogen and phosphorus removal agent has a particle size of 0.8 mm to 1.2 mm, a pH value of 7 to 8, and a temperature of 20° C. to 35° C.

13. The method of claim 1, wherein the phosphorus recovery is conducted in an anaerobic environment with a redox potential of not greater than-100 mV and a pH value of 5 to 8.

14. A system for treating a mature landfill leachate, comprising:
an autotrophic biological nitrogen removal tank;
a coagulation precipitation tank connected to a nitrogen removal solution outlet of the autotrophic biological nitrogen removal tank;
an electrochemical oxidation tank connected to a coagulation precipitation solution outlet of the coagulation precipitation tank, wherein the electrochemical oxidation tank is provided with an electrochemical oxidation residue outlet;
a deep nitrogen and phosphorus removal tank connected to an electrochemical oxidation solution outlet of the electrochemical oxidation tank, wherein the deep nitrogen and phosphorus removal tank is provided with a deep nitrogen and phosphorus removal residue outlet;
a phosphorus recovery device connected to the deep nitrogen and phosphorus removal residue outlet of the deep nitrogen and phosphorus removal tank, wherein the phosphorus recovery device is provided with a residue inlet; and
a humus extraction tank connected to a coagulation precipitation solid outlet of the coagulation precipitation tank, wherein the humus extraction tank is provided with a humus extraction residue outlet; and the residue inlet of the phosphorus recovery device is connected to the electrochemical oxidation residue outlet, the deep nitrogen and phosphorus removal residue outlet, and the humus extraction residue outlet;
the system further comprising a hydrothermal reaction device and a polymerization device.

15. The method of claim 9, wherein the polymerization is conducted at a temperature of 40° C. to 70° C. for 2 h to 4 h.
